(19) United States
(12) Patent Application Publication
(10) Pub. No.: US 2026/0145424 A1
(43) Pub. Date: May 28, 2026

(54) LIQUID EJECTION HEAD, METHOD, AND DEVICE

(71) Applicant: RISO Technologies Corporation, Tokyo (JP)

(72) Inventors: Mengfei WONG, Mishima Shizuoka (JP); Isao SUZUKI, Mishima Shizuoka (JP); Naoki OOISHI, Mishima Shizuoka (JP)

(21) Appl. No.: 19/257,392

(22) Filed: Jul. 1, 2025

(30) Foreign Application Priority Data
Nov. 27, 2024 (JP) 2024-206324

(51) Int. Cl. B41J 2/045; B41J 2/14

(52) U.S. Cl. CPC B41J 2/04588; B41J 2/04541; B41J 2/04556; B41J 2/04573; B41J 2/04581; B41J 2/04596; B41J 2/14201

(57) ABSTRACT

A liquid ejection head includes a nozzle plate including a nozzle, a pressure chamber that is capable of storing liquid and communicates with the nozzle, a volume of the pressure chamber being varied to eject the liquid from the nozzle, an actuator configured to vary the volume of the pressure chamber in response to a drive signal, and a drive circuit configured to generate the drive signal that includes a plurality of ejection waveforms. One of the ejection waveforms follows a preceding ejection waveform after an intermediate time period. The drive circuit is configured to set the intermediate time period based on an ejection speed of the liquid that is 0.2 times or more and 2 times or less of a half cycle of a natural vibration period of the liquid in the pressure chamber.

### CROSS-REFERENCE TO RELATED APPLICATION

This application is based upon and claims the benefit of priority from Japanese Patent Application No. 2024-206324, filed on Nov. 27, 2024, the entire contents of which are incorporated herein by reference.

### FIELD

Embodiments described herein relate generally to a liquid ejection head, method, and device.

### BACKGROUND

A liquid ejection head such as an ink jet head mounted on an ink jet printer is known. The ink jet printer ejects ink droplets from the ink jet head to form an image or the like on the surface of a recording medium. The ink jet head ejects ink droplets from a nozzle that communicates with a pressure chamber by changing the volume of the pressure chamber with a piezoelectric actuator. The operation of the actuator is controlled by a drive waveform input to the actuator.

In the liquid ejection head, a multi-drop drive, which ejects ink droplets a plurality of times, is employed to expand the gradation expression range and ensure ejection stability. Accordingly, the ejection volume and ejection speed must be set to appropriate values. For example, when the acoustic length (hereinafter referred to as AL), which is half of the natural vibration period of the pressure chamber, changes due to changes in the dimensions or structure of the pressure chamber, the ejection speed for a given ejection volume also changes.

### BRIEF DESCRIPTION OF THE DRAWINGS

FIG. 1 is a diagram of a liquid ejection device according to an embodiment.

FIG. 2 is a diagram of a liquid ejection head shown in FIG. 1.

FIG. 3 is a diagram showing a basic ejection waveform in a drive waveform.

FIG. 4 is a diagram showing a drive waveform according to Example 1.

FIG. 5 is a diagram showing a drive waveform according to Example 2.

FIG. 6 is a diagram showing a relationship between an AL and an ejection speed.

FIG. 7 is a diagram of a liquid ejection device according to another embodiment.

FIG. 8 is a diagram showing a drive waveform according to Comparative Example 1.

FIG. 9 is a diagram of pressure chambers and piezoelectric elements.

### DETAILED DESCRIPTION

A liquid ejection head, method, and device capable of adjusting an ejection speed within an appropriate range are provided.

In general, according to one embodiment, a liquid ejection head comprises a nozzle plate including a nozzle; a pressure chamber that is capable of storing liquid and communicates with the nozzle, a volume of the pressure chamber being varied to eject the liquid from the nozzle; an actuator configured to vary the volume of the pressure chamber in response to a drive signal; and a drive circuit configured to generate the drive signal that includes a plurality of ejection waveforms. One of the ejection waveforms follows a preceding ejection waveform after an intermediate time period. The drive circuit is configured to set the intermediate time period based on an ejection speed of the liquid that is 0.2 times or more and 2 times or less of a half cycle of a natural vibration period of the liquid in the pressure chamber.

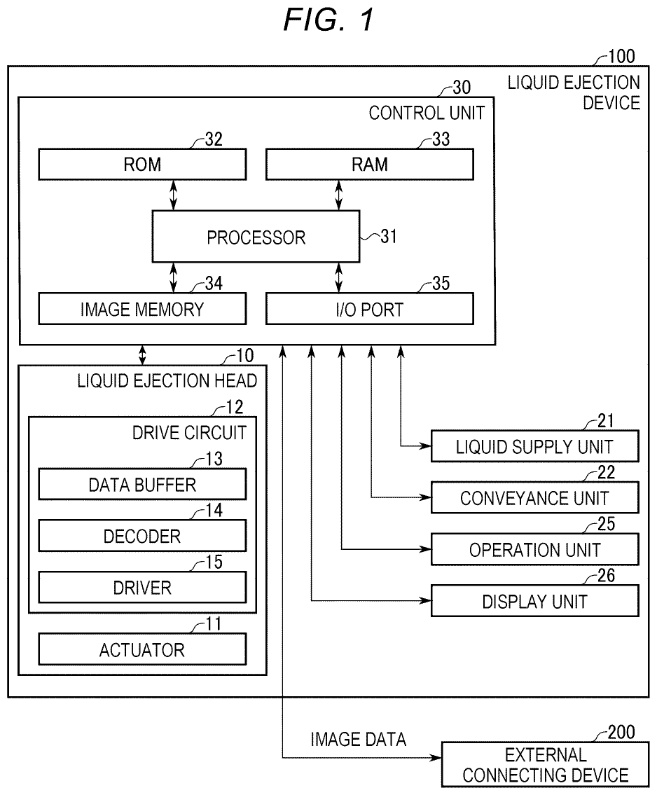

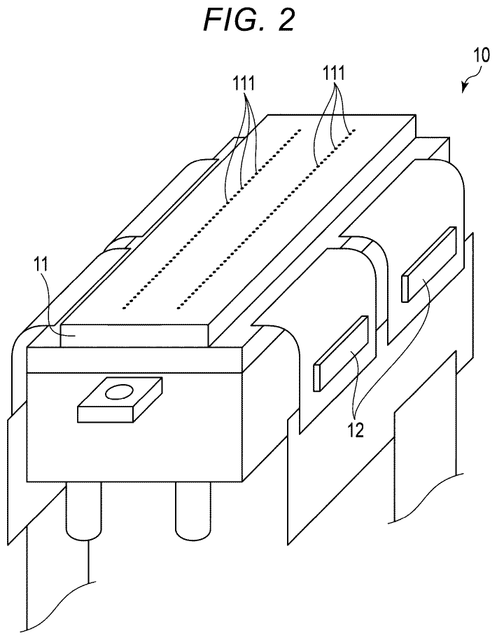

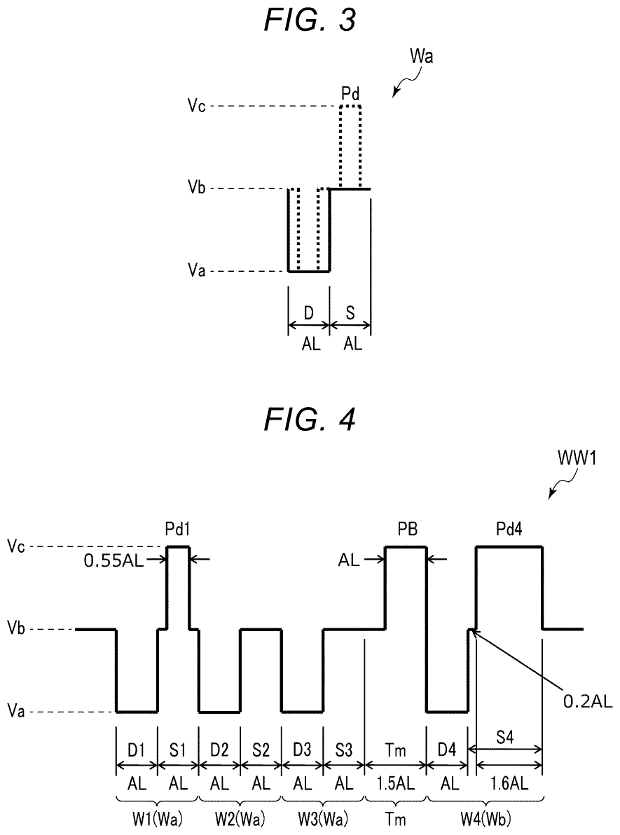

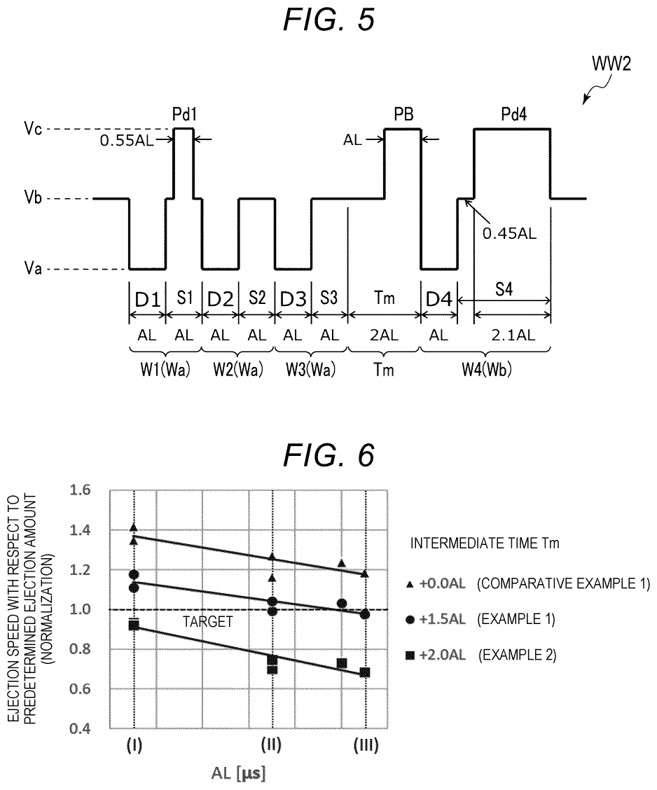

A liquid ejection head 10 (hereinafter also referred to as the drive device) and a liquid ejection device 100 according to embodiments will be described below with reference to FIGS. 1 to 5. FIG. 1 is a block diagram of the liquid ejection device 100, and FIG. 2 is a perspective view of the liquid ejection head 10. FIG. 3 is a diagram showing a basic ejection waveform Wa of a drive waveform according to an embodiment. FIG. 4 is a waveform diagram of a drive waveform WW1 according to Example 1, and FIG. 5 is a waveform diagram of a drive waveform WW2 according to Example 2. FIG. 6 is a diagram showing a relationship between an AL and an ejection speed.

As shown in FIG. 1, the liquid ejection device 100 includes the liquid ejection head 10, a liquid supply unit 21, a conveyance unit 22, an operation unit 25, a display unit 26, and a control unit 30.

The liquid ejection device 100 is an ink jet printer that performs an image forming process on a medium such as paper by ejecting liquid such as ink from the liquid ejection head 10 while conveying the medium such as paper as an ejection target along a predetermined conveyance path passing at a printing position facing the liquid ejection head 10.

The liquid ejection head 10 shown in FIG. 2 is, for example, a shear-mode shared-wall type ink jet head. The liquid ejection head 10 may be a non-recirculation type head that does not recirculate ink, or may be a recirculation type head that recirculates ink. In the present embodiment, the liquid ejection head 10 will be described using the example of the non-recirculation type head.

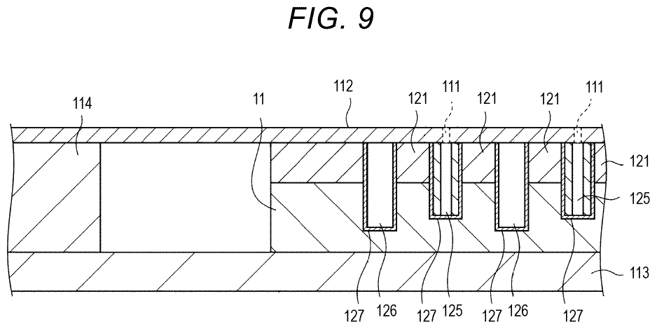

For example, as shown in FIG. 9, the liquid ejection head 10 includes an actuator 11 including a plurality of piezoelectric elements 121 formed between a nozzle plate 112 and a substrate 113, and a drive circuit 12 that drives the actuator 11.

The liquid ejection head 10 includes a plurality of pressure chambers 125 and dummy chambers 126, each of which is connected to an electrode 127. The flow path of the liquid ejection head 10 is formed by a frame 114 and is connected to the liquid supply unit 21, and the ink is supplied from the liquid supply unit to the flow path of the liquid ejection head 10. The actuator 11 applies a voltage to the electrodes 127 of the piezoelectric elements 121 provided corresponding to the pressure chambers 125 to deform the piezoelectric elements 121, so that volumes of the pressure chambers 125 are increased or decreased to eject the ink from the nozzles 111.

The drive circuit 12 drives the actuator 11 by applying a drive voltage to the electrodes of the piezoelectric elements 121. The drive circuit 12 generates a control signal and a drive signal for operating the piezoelectric elements 121. The drive circuit 12 generates the control signal for controlling a timing of ejecting liquid and selection of the piezoelectric element 121 to eject liquid according to an image signal received from the control unit 30 of the ink liquid ejection device 100. In addition, the drive circuit 12 generates a voltage to be applied to the electrodes of the piezoelectric elements 121, that is, the drive signal, according to the control signal. When the drive circuit 12 applies the drive signal to the piezoelectric element 121, the piezoelectric element 121 is driven to change the volume of the pressure chamber 125. That is, the actuator 11 can perform drive control under the control of the control unit 30.

As shown in FIG. 1, the drive circuit 12 includes a data buffer 13, a decoder 14, and a driver 15. The data buffer 13 stores printing data in time series for each piezoelectric element 121 of the actuator 11. The decoder 14 controls the driver 15 based on the printing data stored in the data buffer 13 for each piezoelectric element 121. The driver 15 outputs the drive signal for operating the piezoelectric elements 121 based on the control of the decoder 14. The drive signal is a voltage to be applied to the electrodes of the piezoelectric elements 121.

The liquid supply unit 21 is connected to a primary side of the flow path of the liquid ejection head 10, and supplies the liquid to the flow path of the liquid ejection head 10. For example, the liquid supply unit 21 includes a tank that stores the liquid, a connection flow path that connects the tank and the flow path of the liquid ejection head 10, and a liquid sending pump that sends the liquid in the tank to the liquid ejection head 10.

The conveyance unit 22 conveys a medium such as paper along a predetermined conveyance path and supplies the medium to a printing position. The conveyance unit 22 includes, for example, a plurality of conveyance rollers and conveyance guides disposed along the conveyance path. The conveyance unit 22 supports the medium such that the medium can be moved relative to the liquid ejection head 10.

The operation unit 25 includes function keys such as a power key, a paper feed key, and an error release key.

The display unit 26 includes a display capable of displaying various states of an image printing device.

The control unit 30 is, for example, a control board, and includes a processor 31, a read only memory (ROM) 32, a random access memory (RAM) 33, an image memory 34, and an I/O port 35, which is an input and output port.

The processor 31 is a processing circuit such as a central processing unit (CPU). The processor 31 controls the components of the liquid ejection device 100 to perform various functions of the printer according to an operating system and application programs. For example, the processor 31 controls operations of the liquid ejection head 10, the liquid supply unit 21, and the conveyance unit 22 that are provided in the liquid ejection device 100. During printing, the processor 31 transmits the printing data stored in the image memory 34 to the drive circuit 12 in a drawing order.

The ROM 32 stores the above operating system and the application programs. The ROM 32 may store data necessary for the processor 31 to execute processing for controlling the units.

The RAM 33 stores data necessary for the processor 31 to execute processing. The RAM 33 is also used as a work area in which information is appropriately rewritten by the processor 31. The work area may include an image memory in which the printing data is loaded.

The image memory 34 stores, for example, the printing data from an external connecting device 200.

The I/O port 35 is an interface circuit that receives data from the external connecting device 200 and outputs data to the outside. The printing data from the external connecting device 200 is transmitted to the control unit 30 through the I/O port 35, and is stored in the image memory 34.

The printing data is data to be input to the liquid ejection head 10, and is converted from image data or the like including information on a color and a density image of each region to eject the liquid. For example, as a part of the printing data, information of the AL of the liquid ejection head 10 may be included as a reference related to an ejection speed at a predetermined ejection volume. For example, the AL of the liquid ejection head 10 is input through the external connecting device 200, input as a part of information for setting a drive waveform, and recorded.

Then, the liquid ejection head 10 sets a drive waveform based on the printing data including the AL, and applies the drive waveform to the actuator 11. That is, in the present embodiment, the liquid ejection head 10 serves as a drive device that adjusts an intermediate time of the drive waveform based on the AL.

In the liquid ejection device 100 having such a configuration, the control unit 30 inputs a signal to the liquid ejection head 10 to apply the drive voltage to the drive circuit 12, generates a potential difference between the plurality of piezoelectric elements 121 of the actuator 11, selectively deforms the piezoelectric elements 121, and increases or decreases the volumes of the pressure chambers 125, thereby ejecting the liquid from the nozzles 111. For example, when the volume of the pressure chamber 125 is expanded or contracted during driving, a pressure vibration occurs in the pressure chamber 125. Due to the pressure vibration, a pressure inside the pressure chamber 125 increases, and ink droplets are ejected from the nozzles 111 communicating with the pressure chamber 125. For example, according to the signal received from the control unit 30, the driver 15 applies the drive voltage to the electrodes of the pressure chambers 125 via the electrodes, thereby generating the potential difference between the plurality of piezoelectric elements 121, selectively deforming the piezoelectric elements 121, and changing the volumes of the pressure chambers 125. For example, when the voltage serving as an expansion element is applied, the piezoelectric element 121 is deformed, the volume of the corresponding pressure chamber 125 increases, the pressure decreases, and the ink in the common chamber flows into the corresponding pressure chamber 125. When a drive voltage of a reverse potential is applied to the electrode of the piezoelectric element 121 in a state in which the volume of the pressure chamber 125 is increased, the piezoelectric element 121 is deformed to decrease the volume of the pressure chamber 125, and the pressure increases. Therefore, the ink in the pressure chamber 125 is pressurized and ejected from the nozzle 111.

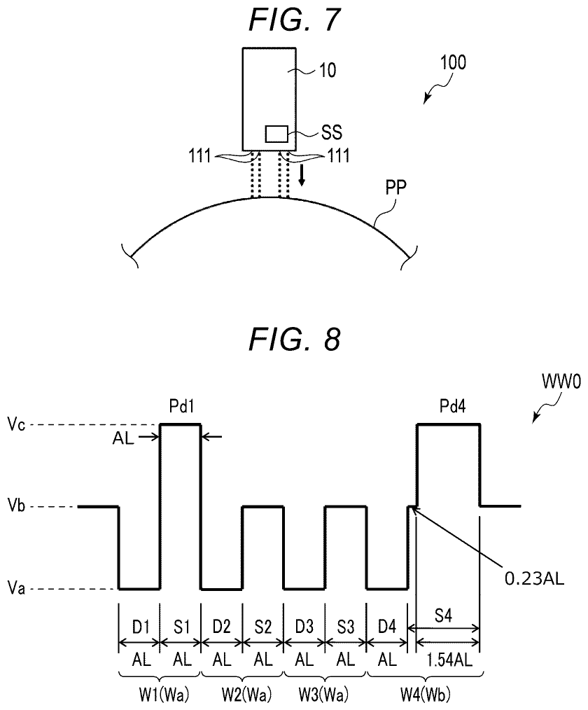

As shown in FIG. 7, in the liquid ejection device 100, when liquid is ejected while the liquid ejection head 10 is moved relative to the medium PP along a conveyance direction, a plurality of dots are formed on the medium PP.

Hereinafter, characteristics of the liquid ejection head 10 used in the liquid ejection device 100 and a drive waveform according to the drive signal generated by the drive circuit 12 of the liquid ejection head 10 will be described. For example, the liquid ejection head 10 employs a multi-drop drive, and can be driven in a plurality of gradations by combining a plurality of drop waveforms. That is, the drive circuit 12 drives with a multi-gradation drive waveform by multi-drop signals having a plurality of patterns or types. Specifically, a condition of the drive waveform is set for each piezoelectric element 121. In the setting of the drive waveform, a drive pattern may be selected for each element from a plurality of patterns set and stored in advance. In the drive method of the liquid ejection device 100, a liquid ejection unit is driven by the drive waveform WW1 to eject n drops of droplets (n is an integer of 2 or more).

Drive waveforms according to the drive signal generated by the drive circuit 12 of the liquid ejection head 10 will be described with reference to FIGS. 3, 4, 5 and 6. FIG. 3 shows a basic ejection waveform Wa used for the drive waveform WW1 according to Example 1. FIG. 4 shows the drive waveform WW1 according to Example 1. FIG. 5 shows the drive waveform WW2 according to Example 2. FIG. 6 is a graph showing the ejection speed at a predetermined ejection volume when the intermediate time is changed. FIG. 8 shows a drive waveform WW0 according to Comparative Example 1. In each waveform diagram, a horizontal axis represents a time, and a vertical axis represents a voltage.

FIG. 4 shows the drive waveform WW1. The drive waveform WW1 is an example of a multi-drop drive waveform for forming one dot by ejecting ink n times (n is an integer of 2 or more) in a drive cycle of one cycle. Waveform data of the drive waveform WW1 is stored in, for example, a memory in the drive circuit 12.

The drive waveform to be input to the actuator 11 may be set or selected by the driver 15 of the drive circuit 12 based on gradation data transmitted from the control unit 30. For example, in the present embodiment, the drive waveform is set based on data on the AL as one piece of the data for setting the drive waveform. The AL can be acquired by, for example, measurement, and is input and stored in advance. A natural vibration period λ for determining the AL can be measured by detecting a change in impedance of the actuator in a state in which the ink is filled.

The drive waveform WW1 according to Example 1 is the multi-drop drive, and includes a plurality of ejection waveforms. The drive waveform WW1 is a waveform having four drops, and has four ejection waveforms W1 to W4 each including the expansion element and a contraction element. That is, the drive waveform WW1 is a drive waveform having a maximum of four drop waveforms or elements in one printing period, and is a waveform driven in a plurality of gradations, for example, five gradations. Here, as an example, the multi-drop drive waveform (n=4) is exemplified in which the number of times of ejection in the drive cycle of one cycle is four drops, but the disclosure is not limited thereto. Periodic lengths T of the ejection waveforms W1, W2, and W3 from 1 to (n−1) are equal.

For example, the drive waveform WW1 is a multi-drop waveform in which, when one pixel is constituted by n drops (n>1), the first drop to a (n−1)-th drop are ejected with the basic ejection waveform Wa, which is the first ejection waveform, and the n-th drop, which is the final drop is ejected with the final ejection waveform, which is the second ejection waveform. For example, the drive waveform WW1 includes the basic ejection waveform Wa from the first drop to the (n−1)-th drop and the final ejection waveform Wb, which is the second ejection waveform. The second ejection waveform is the ejection waveform of the n-th drop. That is, in the drive waveform WW1, the basic ejection waveform Wa is repeated n−1 times, and the final ejection waveform Wb is provided after an intermediate time Tm.

FIG. 3 is a diagram showing an example of the basic ejection waveform Wa. The basic ejection waveform Wa is a so-called pull-ejection drive waveform. The basic ejection waveform Wa includes, for example, an ejection pulse D (D1 to D3) having the expansion element that expands the pressure chamber 125 and the contraction element that contracts the pressure chamber 125. For example, the ejection pulse D decreases the voltage from a first voltage Vb, which is an intermediate voltage, to a second voltage Va lower than the first voltage Vb to expand the pressure chamber 125 (expansion element), and increases the voltage after continuing the second voltage Va for a predetermined time to contract the pressure chamber 125 (contraction element). In addition, the basic ejection waveform Wa includes a contraction waveform element S, which is in a contracted state for the predetermined time after being contracted by the ejection pulse D. For example, in the contraction waveform element S (S1 to S3) after the voltage is returned to the intermediate voltage by the ejection pulse D, the voltage may be maintained for the predetermined time in a state of returning to the first voltage Vb, which is the intermediate voltage. Alternatively, as indicated by a broken line in FIG. 3, the voltage may be further increased to a third voltage Vc higher than the intermediate voltage after the contraction to the first voltage Vb and returned to the first voltage Vb after the predetermined time elapses, so that the waveform includes a damping pulse Pd in which the voltage changes in a stepwise manner.

Therefore, the drive waveform WW1 includes the ejection pulse D (D1 to D3) including the expansion element that expands the pressure chamber 125 and the contraction element that is set to the intermediate voltage after the expansion, and the contraction waveform element S (S1 to S3) after the ejection pulse D (D1 to D3), and includes the damping pulse Pd that contracts as the voltage higher than the intermediate voltage and returns to the intermediate voltage after the contraction in the contraction waveform element S (S1 to S3).

In the basic ejection waveform Wa, as indicated by the broken line in FIG. 3, the pulse width of the ejection pulse D may be set to be smaller than that of the AL.

As an example, each ejection waveform Wa is set to a time width that is twice the AL, whereby AL is a half period of the natural vibration period λ determined by characteristics of the ink and a structure in the head, and a width of the ejection pulse D in the basic ejection waveform Wa is set to the width of the AL. The intermediate voltage is, for example, 0 V, and is also referred to as a reference voltage. For example, a rectangular pulse waveform is exemplified, but the disclosure is not limited thereto, and a trapezoidal waveform may be used.

In the basic ejection waveforms Wa of 1 to (n−1) drop, other than the fourth and the final drop, the width of each pulse is the same, and is set to, for example, the AL. The width of each pulse may be the AL or a time shorter than the AL.

The AL is a half period of a natural vibration period λ determined by characteristics of the ink and the structure in the head. The length of the ejection waveform may be set to be larger than 2AL.

In the drive waveform WW1, the intermediate time Tm is provided between the ejection waveform of one of the drops and the ejection waveform of the next drop. For example, the intermediate time Tm is set between the ejection waveform for ejecting a droplet of the i-th drop (i≥1), which is one of the drops, and the ejection waveform for ejecting a droplet of the (i+1)-th drop, and is set between Si and D (i+1). As an example, the intermediate time Tm is provided between the final ejection waveform Wb of the final drop and the basic ejection waveform Wa of the (n−1)-th drop. Here, the intermediate time Tm is set to a time longer than an interval of the ejection waveform from the drop to the (n−1)-th drop. For example, the intermediate time Tm is set in a range of 0.2 times or more to 2 times or less the AL, or of 0.2 times or more to less than 2 times the AL.

The drive waveform WW1 according to Example 1 may include a boost pulse PB immediately before D4, which is the ejection pulse of the final drop during the intermediate time Tm. The boost pulse PB is a pulse waveform including the contraction element that sets the voltage higher than the intermediate voltage and the expansion element that returns the voltage to the intermediate voltage after the contraction. As a specific example, the boost pulse PB increases the voltage from the first voltage Vb, which is the intermediate voltage to the third voltage Vc, which is higher than the first voltage Vb, and returns the voltage to the first voltage Vb after the predetermined time elapses. For example, a pulse width of the boost pulse PB is preferably the AL, and may be set to a time shorter than the AL.

The final ejection waveform Wb is a so-called pull-ejection drive waveform. The final ejection waveform Wb includes, for example, the ejection pulse D (D4) including the expansion element that expands the pressure chamber 125 and the contraction element that contracts the pressure chamber 125. As a specific example, the ejection pulse D decreases the voltage from the first voltage Vb that is the intermediate voltage to the second voltage Va lower than the first voltage Vb to expand the pressure chamber 125 (expansion element), and increases the voltage after continuing the second voltage Va for the predetermined time to contract the pressure chamber 125 (contraction element). The final ejection waveform Wb includes a contraction waveform element S4 after the ejection pulse D4. The final ejection waveform Wb is a waveform in which the voltage changes in a stepwise manner, and includes a damping pulse Pd4 placed after, in sequential order, the contraction element of the ejection pulse D4 returning to the first voltage Vb, the predetermined time of S4 kept at the first voltage Vb, and the contraction waveform element of S4 further increasing the voltage to the third voltage Vc higher than the first voltage Vb.

That is, the final ejection waveform Wb includes the ejection pulse D (D4) including the expansion element that expands the pressure chamber 125 and the contraction element that is set to the intermediate voltage after the expansion, and the damping pulse Pd (Pd4) that contracts at the voltage higher than the intermediate voltage and returns to the intermediate voltage after the contraction. The final ejection waveform Wb is an ejection waveform having a pulse width longer than that of the basic ejection waveform Wa.

Here, pulse widths of the damping pulse (Pd1) of the first drop and the damping pulse (Pdn) of the n-th drop satisfy Pdn>Pd1≥0.

For example, in the drive waveform WW1, the damping pulses Pd are provided in the ejection waveform W1 of the first drop that ejects a first droplet and the final ejection waveform W4 of the fourth drop. The pulse widths of the damping pulses Pd satisfy Pd4>Pd1, and the width of the damping pulse Pd4 in the ejection waveform W4 is larger than the pulse width of the damping pulse Pd1 in the ejection waveform W1. Therefore, in the drive waveform WW1, the ejection waveform Wn of the n-th drop, which is the final drop, has a pulse width (time) longer than those of the ejection waveforms Wn of first to (n−1)-th drops.

In the present embodiment, the ejection waveform Wa from the second drop to the (n−1)-th drop is a waveform that does not include the damping pulse Pd and allows a predetermined time to elapse at the first voltage Vb after the contraction of the ejection pulse D. In this case, the pulse width of the damping pulse of the ejection waveform W from the second drop to the (n−1)-th drop is zero.

As an example, as shown in FIG. 4, in the ejection waveforms up to (n−1) which becomes the basic ejection waveform Wa, the pulse width of the ejection pulse D and the pulse width of the contraction waveform element S in the contracted state after the ejection pulse D are both AL. For example, the width of the damping pulse in the waveform of the first drop in the contracted state is 0.55 AL. The pulse width of the ejection pulse D4 of the final drop is also AL. In the contracted state of the ejection waveform of the last drop, the pulse width of the damping pulse Pd4 is 1.6 AL, and a holding time before the damping pulse Pd4 is 0.23 AL.

In the drive waveform WW1, the intermediate time Tm is a value set such that the ejection speed corresponding to a predetermined ejection volume approaches a predetermined appropriate value, and is set to a value corresponding to a reference related to the ejection speed. As an example, the intermediate time Tm is set to a numerical value corresponding to the value of AL of the liquid ejection head 10. For example, a length of the intermediate time Tm can be set or adjusted by the drive circuit 12 or the control unit 30. That is, the Tm is adjusted in a direction in which the ejection speed increases as the AL increases and the ejection speed decreases as the AL decreases.

Here, a volume Vd of the droplet to be ejected is defined by an integral of a flow rate passing through the nozzle 111 having a circular cross section with a radius r from a time when a fluid flows to the nozzle 111 to eject the droplet to a time when a flow stops or flows backward. A relationship between the ejection volume Vd and a droplet ejection speed vj is expressed by the following equation.

$${V}_{d} = \int π {r}^{2} {v}_{j} d t \qquad [ Math . 1 ]$$

That is, at a predetermined ejection volume, the ejection speed is inversely proportional to the AL of the time correlated with ejection formation. Therefore, when AL becomes short due to a change in a dimension or structure of the pressure chamber 125, the ejection speed increases with respect to the equivalent ejection volume. When the ejection speed is increased, there is a concern that satellite droplets or tailing after ejection may be formed into mist, and printing quality may deteriorate.

For example, FIG. 5 shows the drive waveform WW2 according to Example 2. The drive waveform WW2 is a waveform in which the intermediate time Tm is set to 2 AL, the damping pulse Pd4 is set to 2.1 AL, and the holding time is set to 0.45 AL. For example, a graph of FIG. 6 shows the ejection speed with respect to the predetermined ejection volume in the drive waveform WW0 of Example 1 in which the intermediate time Tm is set to 1.5 AL, Example 2 in which the intermediate time Tm is set to 2.0 AL, and Comparative Example 1 in which there is no intermediate time. The vertical axis indicates the ejection speed with 1.0 as a target value. The horizontal axis represents AL in μs. The ejection speeds at which the ink is ejected in the waveforms are plotted at three positions having different AL on the horizontal axis. For example, in a range of AL from (II) to (III), the waveform with the intermediate time of 1.5 AL is close to the target value. In this case, by applying a waveform in which the intermediate time is set to 1.5 AL, it is possible to achieve an ejection speed that prevents the satellite droplets or tailing after ejection from being formed into mist. On the other hand, it can be seen that when AL is near (I), the intermediate time between 1.5 AL and 2.0 AL is close to the target value. Therefore, when AL is (I), a waveform is applied in which the intermediate time Tm is, for example, about 1.8 AL. That is, the intermediate time Tm is set and adjusted to be longer as the AL is shorter, and conversely, to be shorter as the AL is longer.

According to the liquid ejection head 10 and the liquid ejection device 100, it is possible to maintain the ejection speed at an appropriate value while preventing satellite mist. That is, if the ejection speed is affected by a change in AL due to the change in the dimension or structure of the pressure chamber 125, the intermediate time Tm becomes longer as the AL becomes shorter, and conversely, the intermediate time becomes shorter as the AL becomes longer, so that the ejection speed can be maintained at an appropriate value by setting and adjusting.

Embodiments and examples of the present disclosure are not limited to the above-described configuration. In the above configuration, an example is shown in which the intermediate time Tm is set between the ejection waveform for ejecting the droplet of the n-th drop, which is the final drop, and the ejection waveform for ejecting the droplet of the (n−1)-th drop, but the disclosure is not limited thereto. For example, the intermediate time Tm may be between the waveform element S1 and the ejection pulse D2 or between the waveform element S2 and the ejection pulse D3. That is, the intermediate time Tm is set between any two ejection waveforms. Note that, the intermediate time Tm is longer than the length between other ejection waveforms in which the intermediate time Tm is not provided.

In the above configuration, an example is described in which the intermediate time Tm is set based on the AL, but the disclosure is not limited thereto. For example, the intermediate time may be adjusted based on another reference instead of the AL. In the liquid ejection head 10 and the liquid ejection device 100 shown in FIG. 7 as another embodiment, the intermediate time Tm is set based on a difference in a landing distance for each row of the nozzles 111. For example, in the present embodiment, the drive circuit 12 or the control unit 30 adjusts the intermediate time Tm of the drive waveform based on a distance to the medium for each nozzle 111 or each row of the nozzles 111.

For example, as shown in FIG. 7, in the liquid ejection device 100, when a medium is disposed on a curved surface such as a roll surface, a distance from a surface on which a droplet lands is different for each nozzle row and for each nozzle 111. For example, as the distance between the nozzle and the surface on which the liquid droplet lands increases, the susceptibility to the air flow increases, and thus landing accuracy tends to decrease. However, if the ejection speed is locally increased in the nozzle 111 that is distant from the surface on which the liquid droplet lands to improve the landing accuracy, an ejection volume increases in conjunction with the ejection speed, and thus unevenness occurs in a landing dot diameter. Therefore, in the present embodiment, the intermediate time Tm is set and adjusted such that the ejection speed for the predetermined ejection volume is increased as a distance between a landing surface and a nozzle surface of an ink jet head increases, or the ejection speed for the predetermined ejection volume is decreased as the distance between the landing surface and the nozzle surface decreases.

As a specific example, the liquid ejection head 10 or the liquid ejection device 100 according to the present embodiment includes a sensor SS that detects a distance to a medium such as laser scanning, and can detect the distance to the medium for each nozzle row or each nozzle 111. The liquid ejection head 10 or the liquid ejection device 100 drives the actuator 11 with the drive waveform WW1 having the intermediate time Tm corresponding to the distance detected by the sensor SS. For example, the intermediate time Tm in the drive waveform WW1 is set and adjusted so as to reduce the influence of the change in the ejection volume generated if the ejection speed is adjusted. The distance may be detected by any other devices other than the sensor SS.

According to this embodiment, by setting the drive waveform WW1 having the intermediate time Tm according to the distance, it is possible to set the ejection speed for the predetermined ejection volume to an appropriate value and to improve the printing quality if the distance to a printing surface on which the droplet is to be landed is different depending on the nozzle 111. For example, the intermediate time Tm in the drive waveform is set according to the distance to the target on which the droplet is landed such that the larger the distance, the faster the ejection speed for the predetermined ejection volume, and the smaller the distance, the slower the ejection speed for the predetermined ejection volume. For example, if the surface on which the droplet lands is separated from an ejection surface of the nozzle 111, it is possible to output a waveform that maintains a predetermined ejection volume by adjusting the intermediate time Tm in the drive waveform for each nozzle row or each nozzle 111 together with the adjustment of increasing the ejection speed.

In the above configuration, an example is described in which the drive circuit 12 that drives the actuator 11 is provided in the liquid ejection head 10 and the liquid ejection head 10 itself serves as a drive device. Alternatively, for example, the liquid ejection head 10 or the liquid ejection device 100 may have a configuration in which the drive device is mounted. The drive waveform to be input to each actuator 11 may be set by the control unit 30, and for example, the waveform is set in a plurality of gradations for each nozzle 111.

In the above embodiments, a method for adjusting the intermediate time may be selected from a plurality of types of waveform patterns stored in advance according to the AL or the distance. Alternatively, the method may be settable by a user according to the AL or the distance. That is, the setting and adjustment of the drive waveform including the adjustment of the intermediate time may be performed in the liquid ejection head 10, or the drive waveform may be settable and adjustable in the control unit or other devices.

That is, as another embodiment, the control unit 30 may be a drive device that adjusts the intermediate time of the drive waveform. For example, the control unit 30 or a processor 31 sets the intermediate time Tm of the drive waveform based on the AL of the liquid ejection head 10. Alternatively, the intermediate time of the drive waveform is set based on the distance of the medium for each nozzle 111 or for each nozzle row. That is, the control unit 30 can adjust the ejection speed of the droplet ejected from the nozzle 111 by increasing or decreasing the intermediate time based on the information of the AL or the distance in addition to selecting and setting the waveform in a plurality of gradations for each nozzle 111.

In the above embodiments, an example of 4-drop driving is described, but the disclosure is not limited thereto, and the number of drops may be 3 or less or 5 or more. Further, the drop waveforms are not limited to two types, and may be three or four or more types combined.

In the above embodiments, the drive waveform for ejecting a maximum of four drops is described, but the disclosure is not limited thereto, and the drive waveform may be, for example, a drive waveform for ejecting a maximum of three drops or less or a maximum of five drops or more.

In the above embodiments, an example is described in which the boost pulse PB is provided at the intermediate time Tm, but the disclosure is not limited thereto. In addition, specific conditions of each waveform can be appropriately changed, and for example, pulse widths may be different. An intermediate damping pulse Pdm smaller than the initial damping pulse Pd1 and the final damping pulse Pdn may be provided in the ejection waveforms W2 and W3 other than the initial and final waveforms. In this case, the pulse widths of the damping pulse (Pd1) of the first drop, the intermediate damping pulse (Pdm) from the second drop to the (n−1)-th drop, and the damping pulse (Pdn) of the n-th drop satisfy Pdn>Pd1>Pdm≥0. Furthermore, the damping pulses Pd1 and Pd4 may not be applied to the first ejection waveform W1 and the last ejection waveform W4.

It is not excluded to provide a delay time shorter than the intermediate time Tm in the waveforms up to the (n−1)-th drop.

The examples are described in which the plurality of ejection pulses have the same pulse width and are rectangular waves, but the disclosure is not limited thereto. For example, the waveform may be a step waveform in which the voltage is switched stepwise, or may be a trapezoidal waveform.

A voltage value applied to each piezoelectric element 121 can be appropriately adjusted according to various conditions. For example, a potential difference may be generated by grounding one of adjacent piezoelectric elements 121 and applying a voltage to the other piezoelectric element 121, or a potential difference may be generated by applying voltages to both of the adjacent piezoelectric elements 121.

For example, the liquid ejection head 10 including the driver 15 is exemplified as an example of the drive device in the above embodiments, but the disclosure is not limited thereto. For example, various control devices such as a control device of an ink jet recording apparatus connected to the liquid ejection head 10 and provided outside the liquid ejection head 10 may be used as the drive device.

The configuration of the liquid ejection head 10 is not limited to the above examples, and the liquid ejection head 10 may be used in a head of another type. For example, the ink jet head is not limited to a configuration in which the pressure chamber 125 is formed between a plurality of columnar piezoelectric elements 121, and can be applied to various other configurations such as a type in which a vibration plate provided between the pressure chamber 125 and the piezoelectric elements 121 vibrates due to the deformation of the piezoelectric element 121.

The ink jet head may be a non-recirculation type head that does not recirculate ink, or may be a recirculation type head that recirculates ink.

Each potential of the drive waveform may be changed, and a voltage value applied to each piezoelectric element 121 may be appropriately adjusted according to various conditions. The piezoelectric element 121 may expand if a voltage is increased and contract if the voltage is reduced, or may expand if the voltage is reduced and contract if the voltage is increased. The order of expansion and contraction in each ejection pulse may also be appropriately set according to various conditions.

The drive waveform is not limited to a pull-ejection waveform, but may be a push-ejection waveform or a push-pull-ejection waveform.

For example, the configuration of the liquid ejection head 10 is not limited to the above examples, and the liquid ejection head 10 may be used in a head of another type. For example, the liquid ejection head may drive a liquid ejection unit by causing vibration of a vibration plate provided between the pressure chamber 125 and the drive element unit by deforming a drive element unit. In addition, a structure in which the ink is ejected by electrostatically deforming a diaphragm, or a heating element type structure in which the ink is ejected from a nozzle 111 using thermal energy of a heater or the like may be employed. In these cases, the diaphragm, the heater, or the like serves as an actuator for applying the pressure vibration to the inside of the pressure chamber 125.

The liquid ejection device 100 is exemplified as an ink jet printer that forms a two-dimensional image with ink on an image forming medium, but is not limited thereto. For example, the liquid ejection device 100 may be a 3D printer, an industrial manufacturing machine, or a medical machine. The liquid ejection device may be a 3D printer, an industrial manufacturing machine, a medical machine, or the like, and may form a three-dimensional object by ejecting, for example, a material substance or a binder for solidifying the material from an ink jet head.

According to at least one embodiment described above, it is possible to achieve both the landing accuracy and the reduction of the satellite mist.

While certain embodiments have been described, these embodiments have been presented by way of example only and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure in the claims and equivalents thereof.

What is claimed is:

1. A liquid ejection head comprising:
a nozzle plate including a nozzle;
a pressure chamber that is capable of storing liquid and communicates with the nozzle, a volume of the pressure chamber being varied to eject the liquid from the nozzle;
an actuator configured to vary the volume of the pressure chamber in response to a drive signal; and
a drive circuit configured to generate the drive signal that includes a plurality of ejection waveforms, wherein
one of the ejection waveforms follows a preceding ejection waveform after an intermediate time period, and
the drive circuit is configured to set the intermediate time period based on an ejection speed of the liquid that is 0.2 times or more and 2 times or less of a half cycle of a natural vibration period of the liquid in the pressure chamber.

2. The liquid ejection head according to claim 1, wherein
at least one of the ejection waveforms includes both an ejection pulse for expanding the volume of the pressure chamber and a damping pulse that is subsequent to the ejection pulse for contracting the volume of the pressure chamber.

3. The liquid ejection head according to claim 2, wherein
the ejection pulse is at a first voltage at an end of the ejection pulse, and
the damping pulse transitions from a second voltage, which is greater than the first voltage, to the first voltage.

4. The liquid ejection head according to claim 2, wherein
the last ejection waveform includes a damping pulse.

5. The liquid ejection head according to claim 4, wherein
one of the ejection waveforms other than the last ejection waveform also includes a damping pulse, and
a width of the damping pulse of the last ejection waveform is greater than a width of the damping pulse of said one of the ejection waveforms.

6. The liquid ejection head according to claim 4, wherein
a width of the damping pulse of the last ejection waveform is greater than the intermediate time period.

7. The liquid ejection head according to claim 2, wherein
a width of the damping pulse of the last ejection waveform is greater than a width of each of the ejection pulses of the ejection waveforms.

8. The liquid ejection head according to claim 1, wherein
the drive circuit is configured to adjust the intermediate time period according to a distance from the nozzle to a target to which the liquid is ejected.

9. The liquid ejection head according to claim 8, wherein
the drive circuit adjusts the intermediate time period such that the ejection speed increases as the distance increases.

10. The liquid ejection head according to claim 1 wherein
the drive signal includes a boost pulse for contracting the volume of the pressure chamber during the intermediate time period.

11. A method for ejecting liquid from a liquid ejection head that includes:
a nozzle plate including a nozzle,
a pressure chamber that is capable of storing liquid and communicates with the nozzle, a volume of the pressure chamber being varied to eject the liquid from the nozzle, and
an actuator configured to vary the volume of the pressure chamber in response to a drive signal, the method comprising:
generating the drive signal that includes n ejection waveforms (n is an integer of 2 or more), wherein
an n-th ejection waveform follows an (n−1)-th ejection waveform after an intermediate time period that is based on an ejection speed of the liquid that is 0.2 times or more and 2 times or less of a half cycle of a natural vibration period of the liquid in the pressure chamber.

12. The method according to claim 11, wherein
at least one of the ejection waveforms includes both an ejection pulse for expanding the volume of the pressure chamber and a damping pulse that is subsequent to the ejection pulse for contracting the volume of the pressure chamber.

13. The method according to claim 12, wherein
the ejection pulse is at a first voltage at an end of the ejection pulse, and
the damping pulse transitions from a second voltage, which is greater than the first voltage, to the first voltage.

14. The method according to claim 11, further comprising:
adjusting the intermediate time period according to a distance from the nozzle to a target to which the liquid is ejected.

15. The method according to claim 14, further comprising:
measuring the distance by a sensor.

16. A liquid ejection device comprising:
a plurality of conveyance rollers configured to convey a medium; and
a liquid ejection head configured to eject liquid to the medium conveyed by the conveyance rollers, the liquid ejection head including:
a nozzle plate including a nozzle,
a pressure chamber that is capable of storing the liquid and communicates with the nozzle, a volume of the pressure chamber being varied to eject the liquid from the nozzle,
an actuator configured to vary the volume of the pressure chamber in response to a drive signal, and
a drive circuit configured to generate the drive signal that includes a plurality of ejection waveforms, wherein
one of the ejection waveforms follows a preceding ejection waveform after an intermediate time period, and
the drive circuit is configured to set the intermediate time period based on an ejection speed of the liquid that is 0.2 times or more and 2 times or less of a half cycle of a natural vibration period of the liquid in the pressure chamber.

17. The liquid ejection device according to claim 16, wherein
at least one of the ejection waveforms includes both an ejection pulse for expanding the volume of the pressure chamber and a damping pulse that is subsequent to the ejection pulse for contracting the volume of the pressure chamber.

18. The liquid ejection device according to claim 17, wherein
the ejection pulse is at a first voltage at an end of the ejection pulse, and
the damping pulse transitions from a second voltage, which is greater than the first voltage, to the first voltage.

19. The liquid ejection device according to claim 16, wherein
the drive circuit is configured to adjust the intermediate time period according to a distance from the nozzle to the medium at a predetermined position at which the liquid is ejected.

20. The liquid ejection device according to claim 19, further comprising:
a sensor configured to measure the distance from the nozzle to the medium.
